(19) United States
(12) Patent Application Publication
(10) Pub. No.: US 2025/0265908 A1
(43) Pub. Date: Aug. 21, 2025

(54) BACCARAT AND BLACKJACK CARD GAMES WITH WAR COMPONENT

(71) Applicant: Bryan E. Pham, Sherman, TX (US)

(72) Inventor: Bryan E. Pham, Sherman, TX (US)

(21) Appl. No.: 18/444,859

(22) Filed: Feb. 19, 2024

(51) Int. Cl. G07F 17/32

(52) U.S. Cl. CPC G07F 17/3293; G07F 17/3225

(57) ABSTRACT

A method of playing a card game including a war game component includes dealing a hand of cards to each of one or more players and to a dealer. A score is calculated of each hand of cards dealt to the one or more players and the dealer. It is determined whether or not there is a winner according to the calculated score based on a predetermined scoring rule. At least one war card is dealt to the one or more players and the dealer when no single winner is identified when the calculated score is a tie score. A winner is identified according to a value of the war card of the one or more players war card and the dealer based on the predetermined scoring rule. In the case of a war tie, multiple cards may be dealt until there is a War card winner. The war card scoring may follow the rules of Baccarat, or may be tallied using the scoring in poker or blackjack.

### BACKGROUND

### Technical Field

The present disclosure generally relates to card games. More particularly, the present disclosure relates to a baccarat game method and an associated type of baccarat table, as well as electronic versions and smartphone apps of card games including but not limited to baccarat.

### Description of the Related Art

Card games such as poker, blackjack, baccarat and casino war are known types of casino games that provide excitement and entertainment to players. In these casino games, there are cards dealt to one or more players.

For example, baccarat is a game present in most casinos. Baccarat is a game that typically uses a standard deck of 52 playing cards. The goal in baccarat is to have a hand that totals as close to 9 as possible. A player may bet on themselves, or on the dealer (in baccarat the dealer is referred to as the “banker”). A tie is typically a “push” where you neither nor lose. In some forms of baccarat, you can bet on a tie being the outcome. The goal is to come to as close to 9 as possible in the value of two cards. An Ace has a value of 1, cards 2 to 9 have their face value, and 10 through King are 0. You receive two cards and if the added value exceeds 9, then only the lowest right digit is used as your score (e.g. a 7 and an 8=15, your score is 5). If your score is an 8 or a 9 you win, and if you have a 6 or a 7 you must stand, 0-5 you are dealt a third card. However, the dealer must draw a third card if a player draws a third card and has a 6 or 7 score. There are additional rules regarding when the dealer must draw a third card.

Blackjack is another game that has been around for many years and is easy to play, as you try to get as close to 21 without going over. The dealer draws at least a third card on 16 or fewer and stands on 17 or higher. If there is a tie, it is sometimes referred to as a “push”, and the player gets their money back.

Texas Hold'em is another popular card game with multiple players in casinos. Two cards, (referred to as “hole cards”), are dealt face down to each player. Five community cards are then dealt face-up in (three) stages. The stages include a series of three cards (“the flop”), later an additional single card (“fourth street”), and a final card (“fifth street”). The object is for each player to obtain the best five-card poker hand out of any combination of the seven cards (e.g., the five community cards and the hole cards). Players can bet to check, call, raise, or fold. Rounds of betting occur and then the flop is dealt. The best hand after all the rounds of betting wins all of the money bet for the hand (the “pot”). A “tie” or “split pot” occurs when two players have hands of equivalent value cards.

Casino war is a game in which players place wagers, then the dealer deals each of player one card face up including the dealer. The player wins when his/her card ranks higher than the dealer's card, and the player loses when his/her card ranks lower than the dealer's card by poker ranking (A, K, Q, J, 10, 9, 8, 7, 6, 5, 4, 3 and 2 is lowest). If the player and dealer have the same value card, there is player decision: either forfeit his/her original wager or go to “war” and make another wager called a “war wager”, and win or lose determined by an additional card draw. If the player's card is a higher ranking than dealer's card, the player wins the original wager. The war wager will vary in amount according to the house rules (every house has different odds pay tables). If the tie is repeated there are different house rules as how to address the situation.

### SUMMARY

The present disclosure includes a method, a computer device, and a smartphone app for card games including a war component.

In one embodiment, a method of Baccarat-war includes dealing two cards additional cards to view and compare with the dealer's cards. The winner is determined according to a Baccarat score system. If it is determined there is a tie with other player or the dealer, then there is a selection to go to war with the other tied players or the dealer. Each of the other tied players or the dealer are dealt additional cards until one of the tied players or the dealer has the highest ranked card and is the winner.

In an embodiment, a method of playing a card game including a war game component, includes dealing a hand of cards to each of one or more players and to a dealer, calculating a score of each hand of cards dealt to the one or more players and the dealer, identifying whether or not there is a winner according to the calculated score based on a set of predetermined scoring rules, dealing at least one war card to the one or more players and the dealer when no single winner is identified when the calculated score is a tie score; and identifying a winner according to a value of the war card of the one or more players war card and the dealer based on one of the predetermined scoring rules.

In an embodiment, the card game and the predetermined scoring rules are based on baccarat.

In an embodiment, the war card scores are based on Baccarat scoring.

In another embodiment, the war card scoring including tie-breakers is based on a highest value card according to poker or blackjack scoring values.

In another embodiment, the war card scoring including tie-breakers is based on an aggregate value of the war cards of each participant in the war card game.

In an embodiment, each of the one or more players are prompted for a baccarat wager and optionally for a war card wager.

In an embodiment, a winner is identified based on the calculated score being closest to 9 in which a tens place digit is dropped off the calculated score when the score exceeds 9.

In an embodiment, the predetermined scoring rules are based on one of blackjack or Texas Hold'em.

In an embodiment, the dealing of a hands of cards includes the dealing of electronic cards.

In an embodiment, the one or more players are prompted for a first wager for a winning score and a second wager for the war card.

In an embodiment, a computer device for playing a baccarat war card game includes one or more processors, a memory coupled to the processor, the memory storing non-transitory executable instructions to cause the processor to perform acts including dealing a hand of cards to each of one or more players and to a dealer, calculating a score of each hand of cards dealt to the one or more players and the dealer, identifying whether or not there is a winner according to the calculated score based on a set of predetermined scoring rules, dealing at least one war card to the one or more players and the dealer when no single winner is identified when the calculated score is a tie score; and identifying a winner according to a value of the war card of the one or more players war card and the dealer based on one of the predetermined scoring rules.

In an embodiment, an app for a smartphone, handheld device, or casino video game includes non-transitory executable instructions stored in the memory of the smartphone, handheld device, or casino video game for a baccarat war card game.

### BRIEF DESCRIPTION OF THE DRAWINGS

The drawings presented herein show illustrative embodiments of the disclosure. They do not illustrate all embodiments. Other embodiments may be used in addition to or instead of the illustrative embodiments. Details that may be apparent or unnecessary may be omitted to save space or for more effective illustration. Some embodiments may be practiced with additional components or steps, and/or without all the components or steps that are illustrated. When the same numeral appears in different drawings, the numeral refers to the same or like components or steps. The drawings are not intended to depict every feature of every implementation nor relative dimensions of the depicted elements, and are not drawn to scale.

FIG. 1 is illustration of a Baccarat-War (BW) casino table, consistent with an illustrative embodiment.

FIG. 2 illustrates a graphic image of the BW casino table of FIG. 1, consistent with an illustrative embodiment.

FIG. 3 illustrates a BW card game in progress after two cards have been dealt to each of the players and the dealer, consistent with an illustrative embodiment.

FIG. 4 illustrates further status of the players of the BW card game in progress, consistent with an illustrative embodiment.

FIG. 5 illustrates the types of hands of BW card game in progress and an update on a four-card side wager, consistent with an illustrative embodiment.

FIG. 6 illustrates the BW card game with multiple players having tied hands, consistent with an illustrative embodiment.

FIG. 7 illustrates the BW card game in progress when a player and the dealer still have tied hands after a third card is dealt, consistent with an illustrative embodiment.

FIG. 8 illustrates the BW card game in progress when player 7 wins on the fourth card, consistent with an illustrative embodiment.

FIG. 9 illustrates the BW card game in progress when two players are tied for the war pot, consistent with an illustrative embodiment.

FIG. 10 illustrates the BW card game in progress when six cards are needed to determine the War pot winner, consistent with an illustrative embodiment.

FIG. 11 illustrates the BW card game in progress when there are multi-tiered ties among the players and the dealer, consistent with an illustrative embodiment.

FIG. 12 illustrates the BW card game in progress when player 3 is eliminated and players 5 and 7 have a repeat tied hand, consistent with an illustrative embodiment.

FIG. 13 illustrates the BW card game in progress when players 5 and 7 have a tied hand after a fourth card is dealt, consistent with an illustrative embodiment.

FIG. 14 illustrates the BW card game in progress when after 7 cards being dealt, player 7 wins, consistent with an illustrative embodiment.

FIG. 15 is a flowchart illustrating a computer-implemented method of playing a card game including a war game component, consistent with an illustrative embodiment.

FIG. 16 illustrates the components of a computing device used for an electronic card game with a war component, consistent with an illustrative embodiment.

### DETAILED DESCRIPTION

In the following description, numerous specific details are set forth to clearly describe various specific embodiments disclosed herein. One skilled in the art, however, will understand that the subject matter of the present disclosure may be practiced without all of the specific details discussed below. In other instances, well-known features may not have been described so as not to obscure the invention with unnecessary detail regarding known features.

As used herein, the term “and/or” is to be interpreted broadly, and is to be understood as referring to all or some of the elements. For example, “at least one of (a) and/or (b) means the teaching pertains only to element (a), or only to element (b), or to both element (a) and element (b). In another example, “at least one of (a), (b), and/or (c), means the teaching pertains to only element (a), or only to element (b), or only element (c), or to elements (a) and (b), elements (a) and (c), elements (b) and (c), or to all of (a), (b) and (c).

Also, it is to be understood that the phraseology and terminology used herein are provided for the illustrative purposes and should not be regarded as limiting. The use of “including,” comprising, “or “having” and variations thereof herein is meant to encompass the items listed thereafter and equivalents thereof as well as additional items. Unless limited otherwise, the terms “connected,” coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that embodiments of the present disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the invention may be implemented in software. As such, it should be noted that a plurality of hardware and software-based devices, as well as a plurality of different structural components, may be utilized to implement the subject matter of the present disclosure. Furthermore, and as described in subsequent paragraphs, the specific mechanical configurations illustrated in the drawings are intended to exemplify embodiments of the subject matter of the present disclosure.

Appendix A includes an example of predetermined scoring rules of a Baccarat War card game according to the present disclosure. The appended claims are not limited to being practiced according to the predetermined scoring rules in Appendix A, as these rules are provided as a guide to aid in understanding of the operation of a method, system and device of the present disclosure. For example, it is understood that the players in the games are not limited to wagers on their own hands. In addition, players may place wagers on Baccarat and War based on player decisions, or must wager on both Baccarat and War and/or a War pot dealer with or without participating before the cards are dealt.

### Overview

According to some illustrative embodiments, the presently disclosed method and system may be implemented using a computing device such as, for example, computer, mobile phone, cellular phone, a tablet, and/or laptop. According to some embodiments, the presently disclosed App may be implemented using a computing device such as, for example, a computer, mobile phone, cellular phone, tablet, and/or laptop.

The computing device may have more or fewer components than described below, may combine two or more components, or a may have a different configuration or arrangement of the components. The various components described below may be implemented in hardware, software or a combination of both hardware and software, including one or more signal processing and/or application-specific integrated circuits.

According to some embodiments, the computing device may have a memory (which may include one or more computer-readable storage mediums), one or more processing units (e.g., CPU's), an audio circuitry, a speaker, in accordance with some embodiments. These components may communicate over one or more communication buses or signal lines.

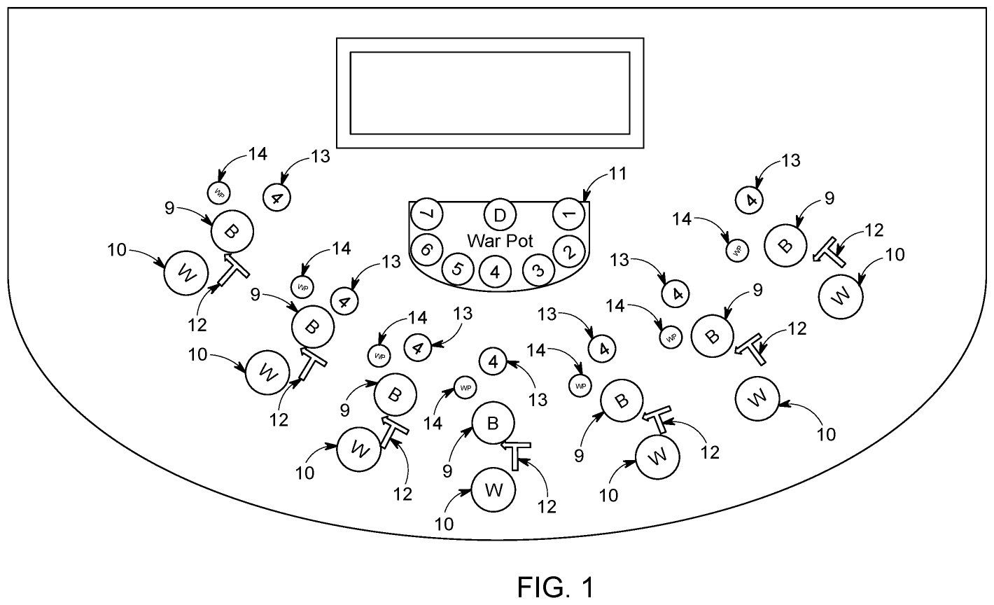

FIG. 1 is illustration of a Baccarat-War (BW) casino table, consistent with an illustrative embodiment. FIG. 1 shows a BW casino table 101 with a dealer area 103, a war pot center 105, the war pot center 105 showing a map of players 1 to 7 (107) and having a position for the collected wager of each player's war pot wager (assuming there are 7 players). For each player there is a baccarat wager area 119, and a war wager area 100. There is a tie wager area 120 for each player to bet on a tie score. There is also a player four-card wager area 130, and a war pool wager area 140. The four-card wager area 130 is a spot for each player to place a four-card side bet, and the war pool wager area 140 is a spot for each player to place their war bet. The dealer will collect the war pool wagers and place them in the war pot center 105, which is rewarded to a player or dealer first having the initial highest score of tier tied hands, then each competitor of the highest tier tie receives one card until there is a winner, and/or a third card closest to 9, all scored according to a Baccarat system.

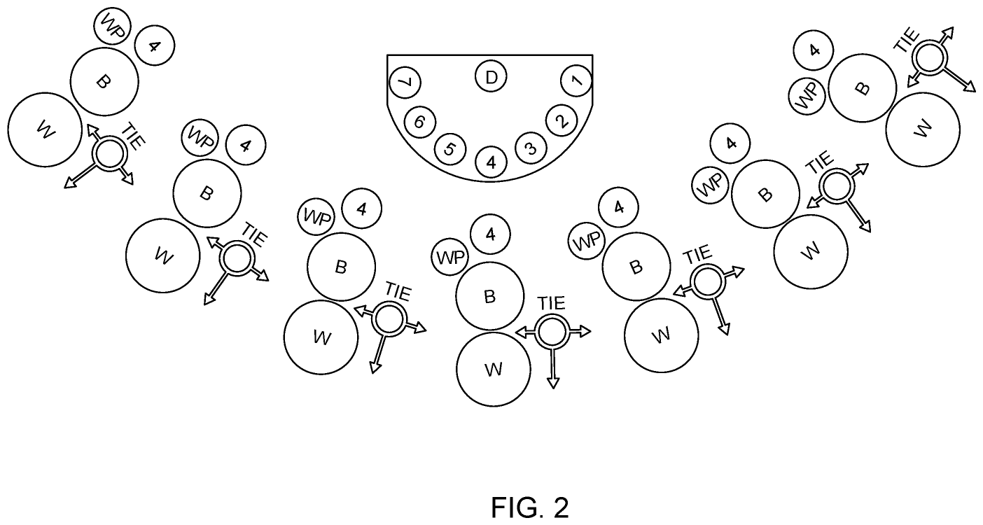

FIG. 2 illustrates a graphic image 200 of the BW casino table of FIG. 1, consistent with an illustrative embodiment. FIG. 2 is identical to FIG. 1 in terms of a war pot center 105, and map of the player's wagers 107 in the war pot center 105. In addition, the four-card wager area 130, and a war pool wager area 140, baccarat wager area 119, and a war wager area 100 are all shown. This graphic image 200 may be displayed on video screens, smartphones, tablets, laptop computers, etc., that have an open BAC-War application according to the present disclosure.

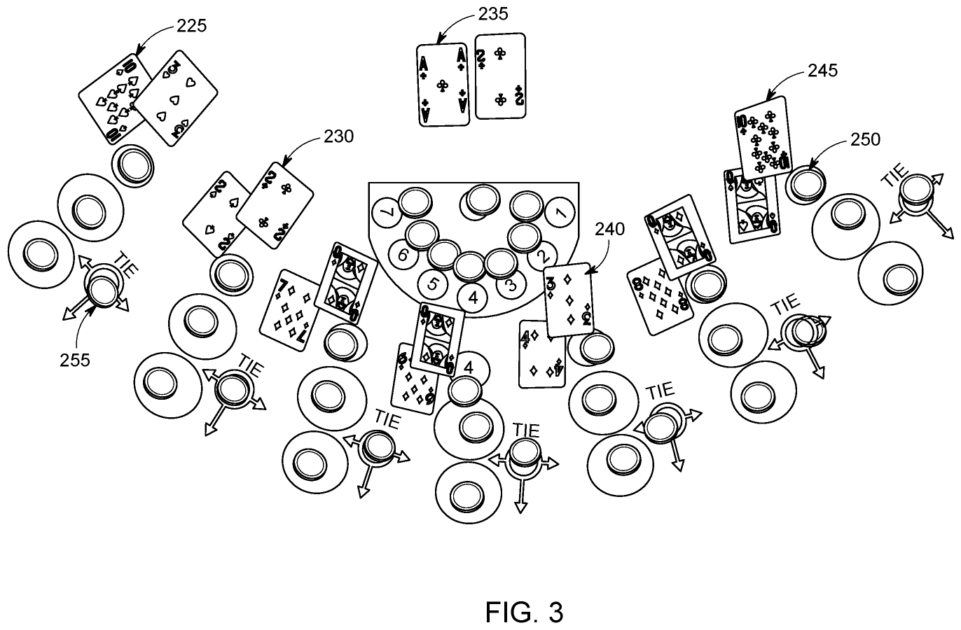

FIG. 3 illustrates the BW card game in progress after two cards have been dealt to each of the players and the dealer, consistent with an illustrative embodiment. Players 1-7 and the dealer are shown. The dealer has hand 335, player 7 has hand 325, player 6 has hand 330, player 3 has hand 340, and player 1 has hand 345. There is shown a chip on the four-card wager 350, and a tie wager 355 made for each of the players.

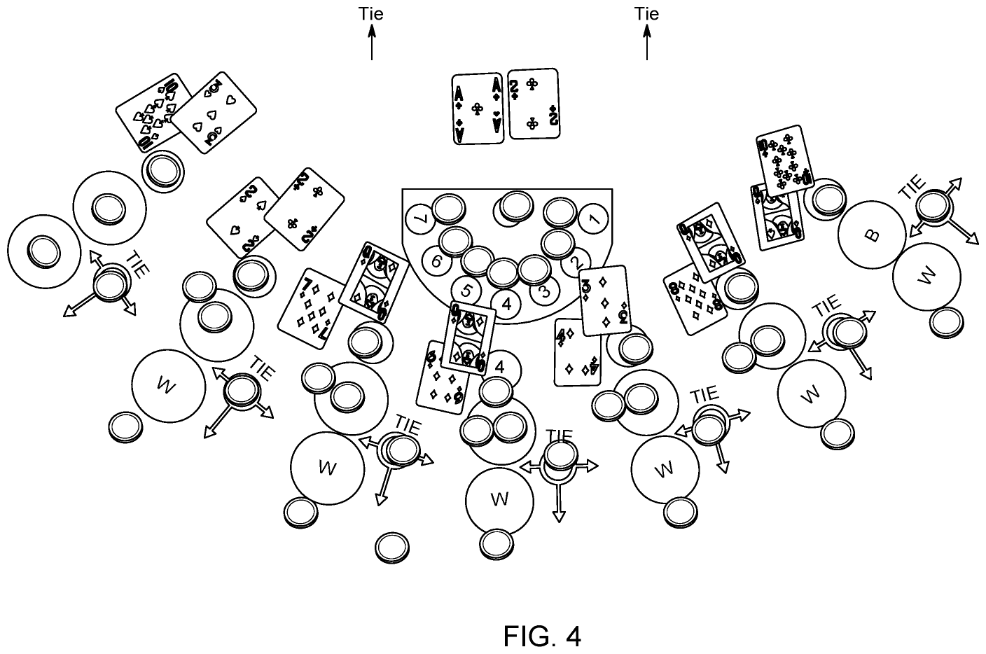

FIG. 4 illustrates further status of the players of the BW card game in progress, consistent with an illustrative embodiment. In FIG. 4, the dealer 420 has a score of 3. The player 430 (in spot 1) has a ten and a queen (losing on BAC and getting a push on WAR). Player 425 (spot 2) and players 3, 4, 5, and 6 win BAC and get a push on WAR. Player 411 (spot 7) and the dealer 420 have a lowest tied tier with each player having a score of 3, so they need to finish the BAC hand, and a winner of the WAR wager is determined by drawing one or more cards to determine a winner, prior to players 435 (spot 3_and player 430 (spot 5) starting play for the WAR Pot. It is noted that players 430 and 435 have a highest tier tied hand (each with a score of 7).

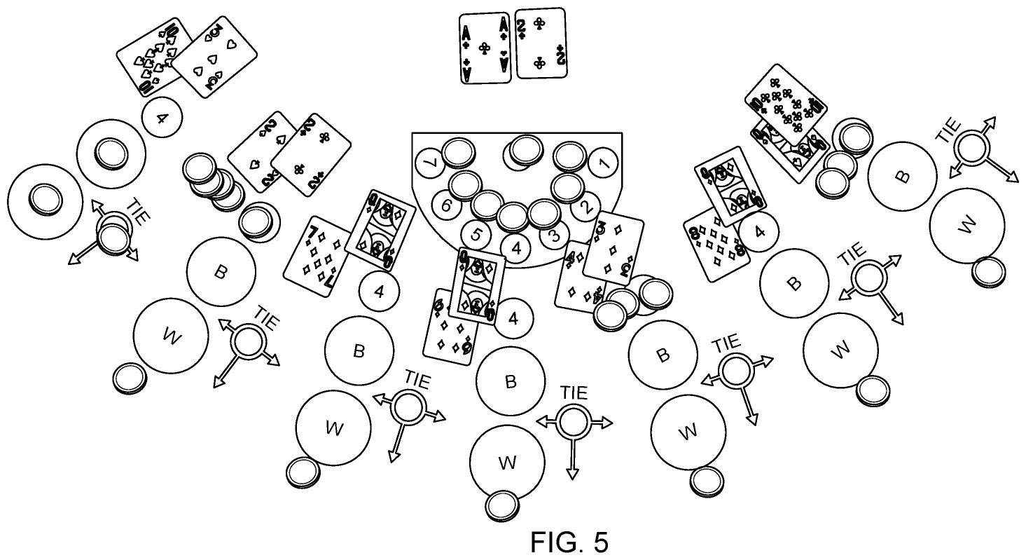

FIG. 5 illustrates the types of hands of BW card game in progress and an update on a four-card poker side wager, player initially with two cards and the dealer initially with two cards, consistent with an illustrative embodiment. In FIG. 5, after drawing an additional card, player 515 has a flush, player 520 has a straight, player 525 has a trip of 2s, and all the other hands lost on the four-card poker side wager.

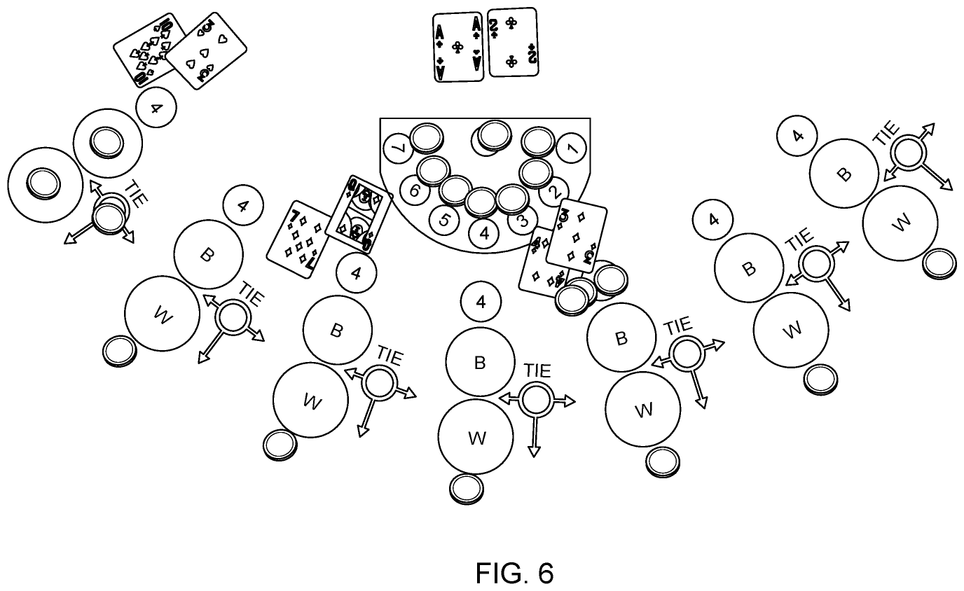

FIG. 6 illustrates the BW card game with multiple players having tied hands, consistent with an illustrative embodiment. In FIG. 6, there are multi-tier tied hands (player 615 and player 620) each have a score of 7, and the dealer 601 has a score of 3, which is tied with player 605. The highest-ranking tied hands will play for the WAR Pot, so the dealer 601 has a lower tier tied with player 605) must finish their hands.

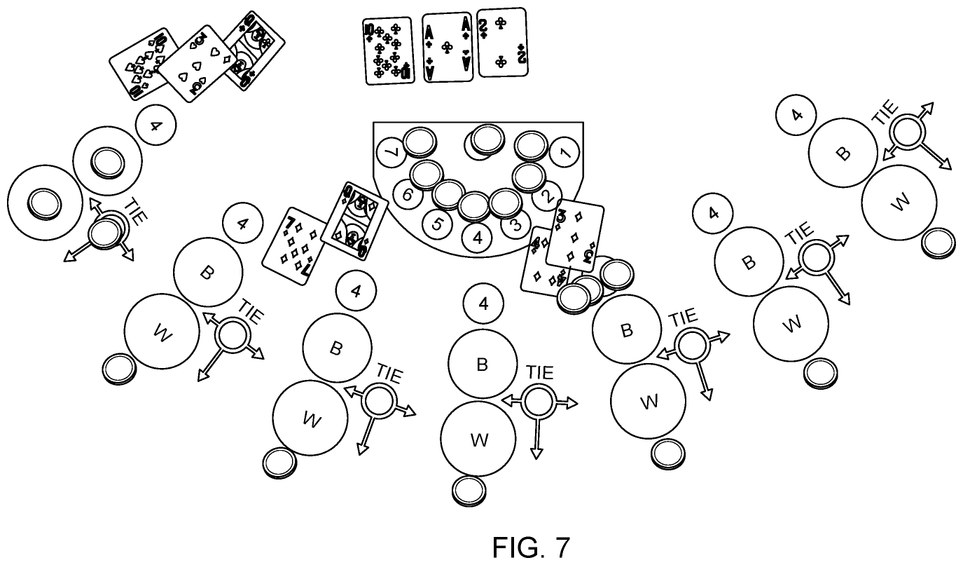

FIG. 7 illustrates the BW card game in progress when a player and the dealer still have tied hands after a third card is dealt, consistent with an illustrative embodiment. In FIG. 7, the player 711 and dealer 701 are still tied after the third card is dealt (they both have a BAC score of 3), and the player and dealer must draw one or more additional cards to determine a winner (each draw to a tied hand is only one card). Player 715 and player 720 both are tied with a BAC score of 7.

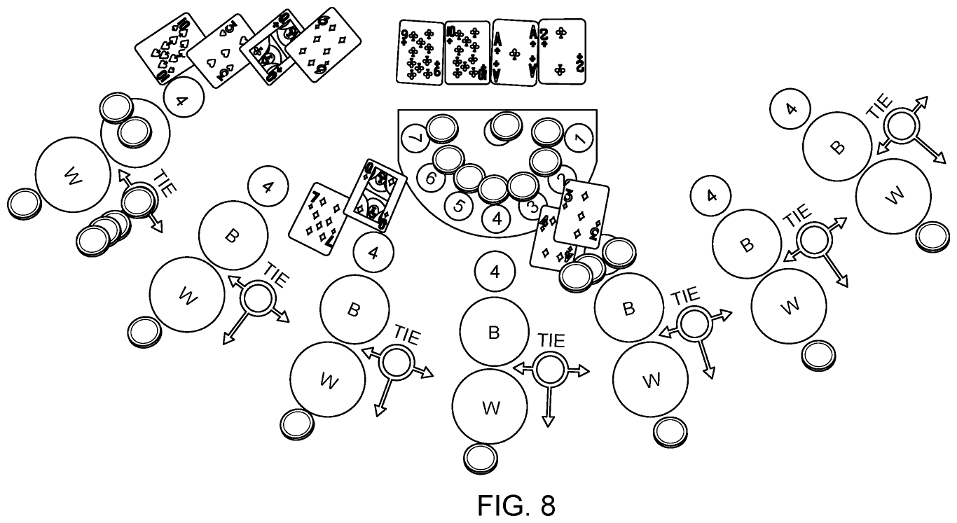

FIG. 8 illustrates the BW card game in progress when player 7 wins on the fourth card, consistent with an illustrative embodiment. In FIG. 8, the player 811 won on the fourth card which is 6+Q+3+10=29 modulo 10=9 points over ranking of the dealer's hand 801 of 2+1+10+9=22 modulo 10=2 points, which is lower than player 811 hand of 9 points. The player 811 is rewarded with the BAC wager and WAR wager, The player 811 may get pay or a push depending on the casino hosting the game. The player 811 at spot 7 had a tied hand with the dealer 801, so a tie side wager gets paid.

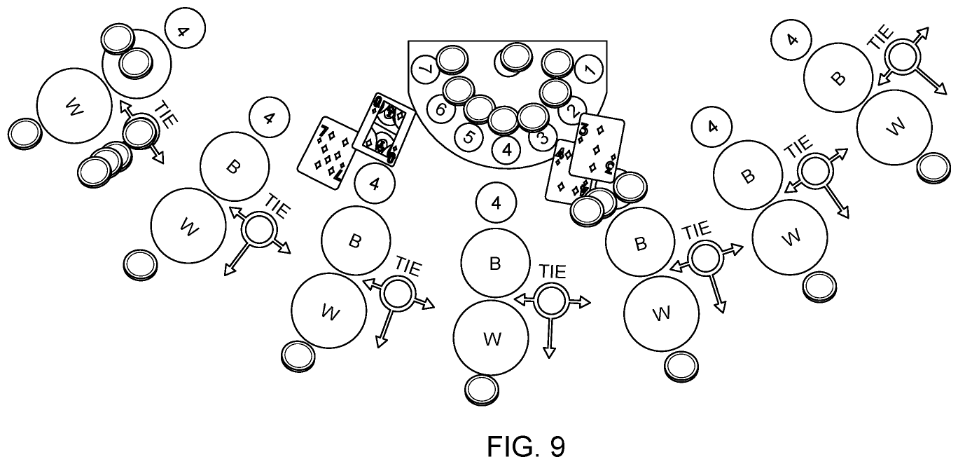

FIG. 9 illustrates the BW card game in progress when two players are tied for the war pot, consistent with an illustrative embodiment. After the dealer 801 and player 811 (shown in FIG. 8) finished their lower tier tied hands, players 920 (spot 3) and player 915 (spot 5) now contest for the WAR Pot. Each player 920, 915 draws one or more cards for each the WAR Pot to determine a winner.

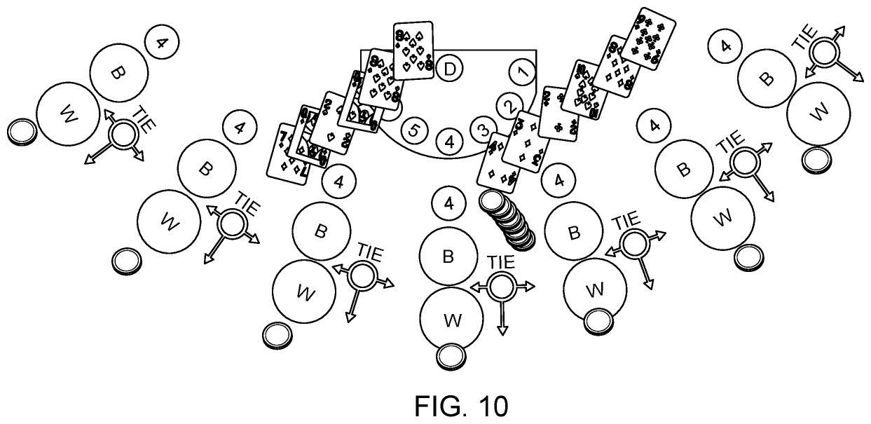

FIG. 10 illustrates the BW card game in progress when six cards are needed to determine the War pot winner, consistent with an illustrative embodiment. Player 1020 (spot 3) and player 1015 (spot 5) had many repeats ties until the sixth card, player 1020 is a winner with the hand 4+3+2+10+8+9=36 (drop the first digit this hand score is 6), and player 1015 (spot 5) has 7+Q+2+Q+8+8=45, drop first digit, then the hand score is 5, and player 1020 wins the WAR Pot.

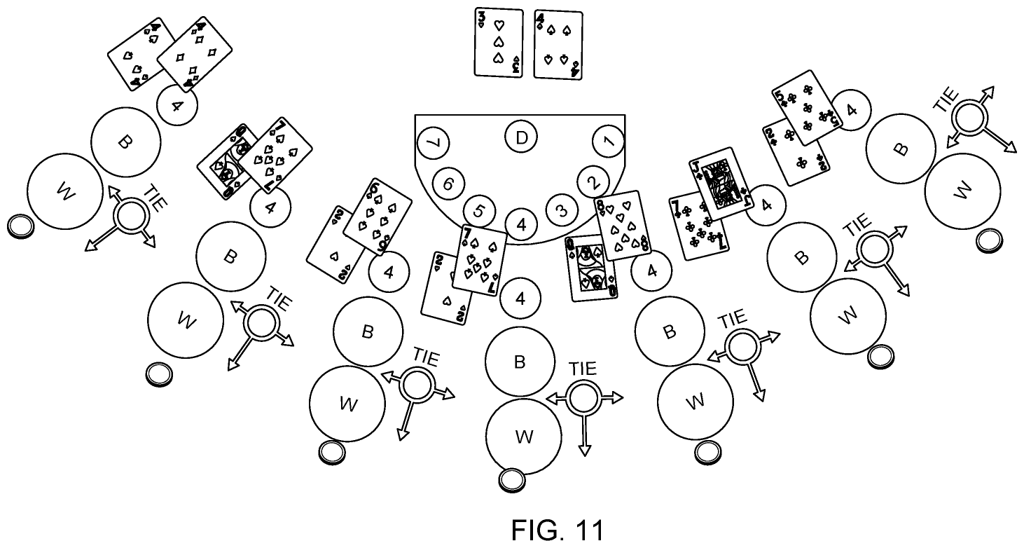

FIG. 11 illustrates the BW card game in progress when there are multi-tiered ties among the players and the dealer, consistent with an illustrative embodiment. There multi-tier ties, the higher tied hands will contest for the pot which as players 1111, 1115 and 1120 (spots 7. 5 and 3) are tied with a score of 8. All other players are terminated, including the dealer's hand.

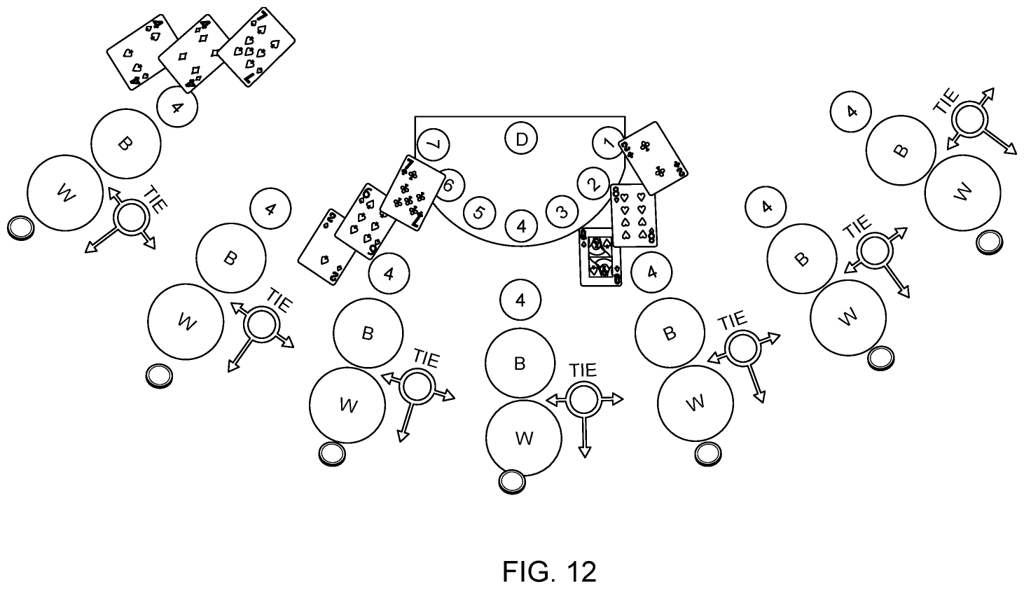

FIG. 12 illustrates the BW card game in progress when player 3 is eliminated and players 5 and 7 have a repeat tied hand, consistent with an illustrative embodiment. After receiving an additional card, player 1211 and player 1215 have a repeated tied hand of 15, and player 1220 (spot 3) loses because player 1220 has a total of zero points after receiving the third card. Player 1211 and player 1215 each receives additional card(s) until there is a winner.

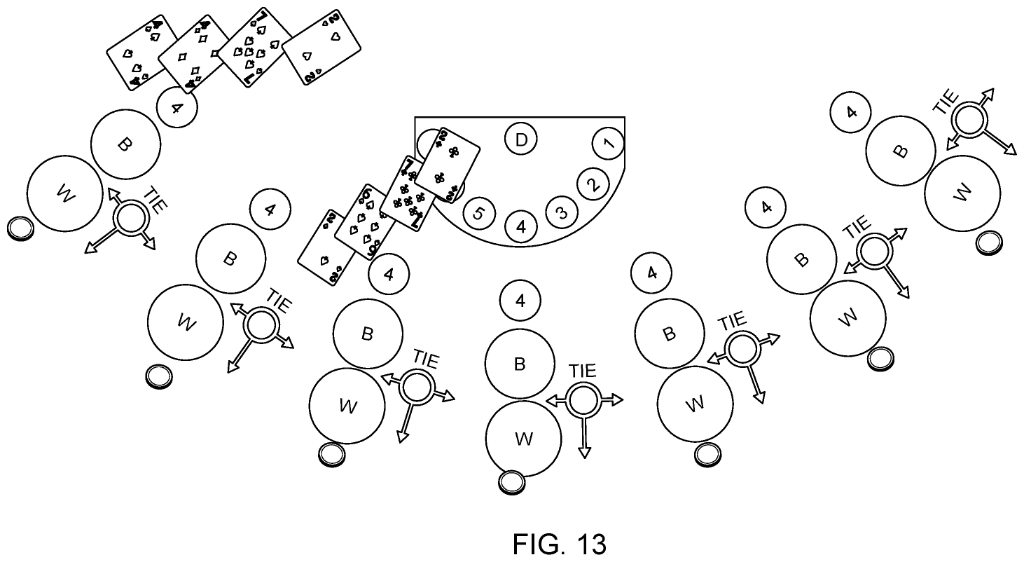

FIG. 13 illustrates the BW card game in progress when player 1311 and player 1315 have a tied hand after a fourth card is dealt, consistent with an illustrative embodiment. Each of players 1311 and 1315 have a score of 17, so they continue to draw more cards until there is a winner.

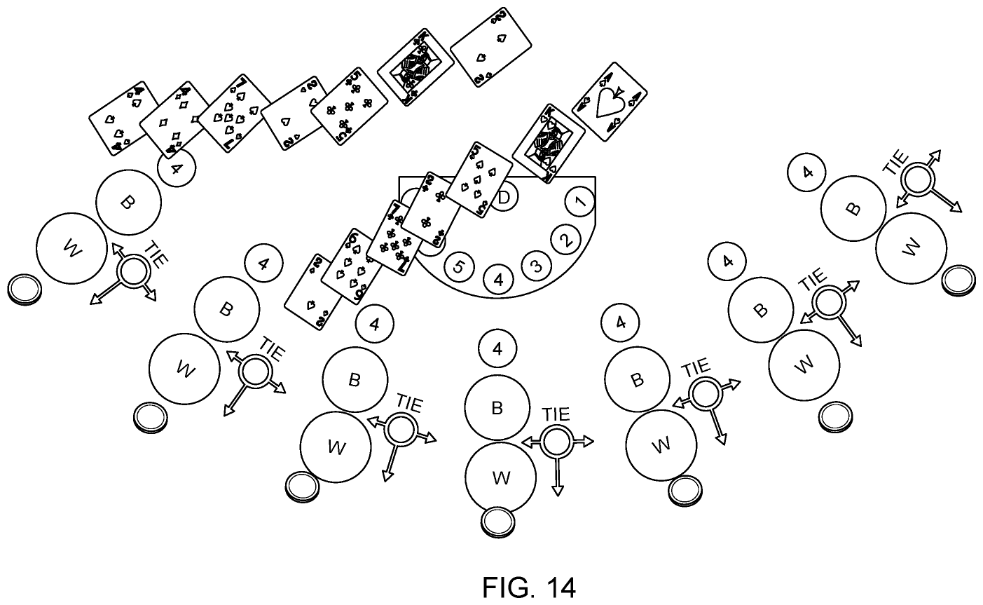

FIG. 14 illustrates the BW card game in progress after 7 cards being dealt, consistent with an illustrative embodiment. Player 1411 wins with a score of 4, where player 1415 has a score of 3. In FIG. 14, which is the continuance of a game shown in FIGS. 10 through 13, the remaining two players 1411, 1415 drew up to a 5th card to break the tie.

### Computer-Implemented Method

With the foregoing overview of the example architecture, it may be helpful now to consider a high-level discussion of an example process. To that end, FIG. 15 is a flowchart illustrating a computer-implemented method of a card game with a war component, consistent with an illustrative embodiment.

FIG. 15 is shown as a collection of blocks, in a logical order, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement data. In each process, the order in which the operations are described is not intended to be construed as a limitation, and any number of the described blocks can be combined in any order and/or performed in parallel to implement the process.

At operation 1501, a hand of cards is dealt to each of one or more players and to a dealer. The cards may be physical cards, or electronic cards displayed on a display screen. In the case of a BW card games, the number of cards card dealt are according to the rules of baccarat.

At operation 1503, a score is calculated for each hand of cards dealt to the one or more players and the dealer. The scoring may be calculated according to the predetermined scoring rules of the game being played such as shown in Appendix A, including but not in any way limited to baccarat, baccarat war, poker, Texas Hold'em, blackjack, etc.

At operation 1505, it is determined whether or not there is a winner according to the calculated score based on the set of predetermined scoring rules. For example, in the case of baccarat or baccarat war, at least one standard deck of 52 cards is used ranging from an Ace (counts as 1), 2-9 face value cards, and the 10s, Jacks, Queens, and Kings count as 0. The scoring is similar to Baccarat, for example, if the hand exceeds a count of 9, only the rightmost digit is used as the score (e.g., 13 becomes 3). For example, example: 9+8=17, the score is 7. In another example, a hand of 8+6+7+5+5 equals 31, and the score would be 1 (the rightmost digit).

If there is a winner at operation 1505, that winner may be paid or credited with a win (operation 1515). There may be multiple winners according to the wager on the player or the dealer hands. However, if there is no winner at operation 1505, then at operation 1507 a war card is dealt to the participants of the war pot.

At operation 1509, it is determined whether there is a winner of the war card pot. If there is a tie scored, then operations 1507 and 1509 repeat until there the tie is broken and there is a war card winner.

At operation 1511, the winner of the war pot is paid or credited with the amount in the war pot (e.g., the chips in the war pot 205) based on one of the predetermined scoring rules.

It is to be understood that the computer-implemented method of FIG. 15 is not limited to the operations discussed herein above and may include other operations.

FIG. 16 illustrates the components of a computing device used for an electronic card game with a war component, consistent with an illustrative embodiment. It is to be understood that the components shown in FIG. 16 are provided for illustrative purposes, and the present disclosure is not limited to the arrangement shown. A number of the components shown are optional, and there may be fewer components arranged differently than shown. The computing device shown in FIG. 16 is presented for illustrative purposes and there may be fewer elements or more elements than shown in described. The computing device used in FIG. 16 may operate in part according to the flowchart of FIG. 15, to provide a card game (e.g. baccarat, baccarat war, poker with a war feature, Texas Hold'em with a war feature, etc.)

Communication bus 1601 shown in FIG. 16 is used to link the processor 1605, storage 1610, communication interface 1607 and optional display 1620. It is to be understood that in place of a unidirectional bus connected to the elements, there may be dedicated buses between the components. Additional elements such as a cache storage may be present. The communication interface may include an antenna 1616 for wireless communication with a network server of a casino or game host. The computing device may also connect to the Internet 1618 via cellular, Ethernet, etc. No particular type of communication is restricted, and the communications between the computing device and a server, host or casino may be encrypted. The processor 1605 executes code from the storage 1610. The executable code may include instructions and updates for a number of operations including baccarat war (BAC-WAR) 1611, WAR 1612, Texas Hold'em 1613, and/or poker 1614. The executable code may be apps or modules pre-loaded into storage, or provided by a game store or host via the communication interface 1607. Games may be updated, removed, added, etc., via the communication interface 1607. The display 1607 may have instruction prompts for the games, depositing and withdrawing money or credits, and may display, for example, a baccarat table such as the BW table shown in the embodiments of shown herein.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,’ ‘an,” and “the” include plural referents unless the content clearly dictates otherwise. The term plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one’, unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, paragraph (f), unless the element is expressly recited using the phrase “means for”, and no method or process step herein is to be construed under those provisions unless the step, or steps, are expressly recited using the phrase “step(s) for . . . .”

### Appendix A

### Predetermined Rules

In a method and device for playing card games including Baccarat-War, the following are suggested rules that may be varied by the house or players prior to undertaking the card game.

At least one standard deck of 52 cards is used ranging from an Ace (count as 1), 2-9 face value cards, and the 10s, Jacks, Queens, and Kings count as 0. The scoring is similar to Baccarat, for example, if the hand exceeds a count of 9, only the rightmost digit is used as the score (e.g., 13 becomes 3). For example, example: 9+8=17, the score is 7. In another example, a hand of 8+6+7+5+5 equals 31, and the score would be 1 (the rightmost digit).

In the case of a player against the dealer, a dealer always participating in the WAR Pool with players in the table, each of player making wagers on Baccarat, War and or Tie. Four card side wagers and WAR Pot wager are made first.

BAC/WAR wagers are compared and resolved, the hand then side wagers according to the rule of the game and pay table, the WAR Pool wagers are combined into the WAR Pool center which is rewarded to a player or a dealer: (1) having the initial highest scored of tier tie hands then each competitor higher tier tie shall receive one or more cards until there is a winner and the lower tiers tie has terminated; the second is a tie hand. Each competitor shall receive one (or more) cards until there is a winner, and or third initial of two cards hand closest to nine, all scoring is according to the Baccarat score system. The second is a tie hand draw of one or more cards until there is a winner. The system can be played with handheld devices, table remote, computer, slots or games control by player terminals. The War pot scoring may use the rules of Baccarat (e.g., dropping of the higher digit, counting face cards as 0, etc.), or the War score may be calculated using a high point total based on the face value of the cards according to poker or blackjack rules without dropping second order digits such as in Baccarat.
1) A method playing of this invention Including tablets, computers, remote tables or handheld devices. using at least standard deck of 52 cards ranging 2-9 face value, Ace count 1 and King, Queen, Jack, ten counts zero, the score system like Baccarat closed to nine is highest hand but NOT concluded rules standings nor stopping cards of initial two card hands.
2) player make BAC/WAR(119/100) and or optional WAR Pool(14), tie(120) or 4 cards(130) side wagers, the dealer collecting participants player's and dealer's WAR Pool(100) wager to WAR Pool center(105) and dealt two cards to-each player and dealer, each of player's initial hand compare to dealer initial hand by Baccarat score system which is closed to nine is highest hand, example: for two cards is 9+8 equal 17 modulo the 10 kept the right digit is 7 points and or 3 cards or more 7+8+8+6 equal 29 modulo the tens the points is 9.
3) players won if his/her initial hand closed to nine points than dealer, he/she shall be rewarded BAC(119) and WAR(100) wager is pushed,
4) if the players initial hand lowered than dealer hand, his/her forfeit the BAC(119) and WAR(100) wager is pushed
5) if any players hand tie with dealer hand then the BACWAR(119/100)/wager shall be competing by each of player tie with dealer hand shall drawing once card to determined winner by baccarat score system,
6) the players win if his or her closed to nine points than dealer he/she shall rewarded the BAC(119) wager and WAR(100) wager maybe reward or pushed it's depending the house hosting game,
7) player lost if his/her hand lower score than dealer hand the BAC/WAR(119/100) wagers shall be forfeited,
8) if there repeats tie then continue draw once or more card until the hand has declared a winner.
9) WAR Pool(140) wager competition: any ties initial hand including dealer then shall be complete.
10) During the round playing to competing WAR pool, if there are multi-tier ties then higher tier tie shall compete for the WAR Pool, and if any player's and dealer's lower tie then the player and dealer shall be completed the hand, before player's highest tier tie hands to compete. FIGS. 3-8
11) This is ordered to WAR Pool compete: starting highest score of multi-tiers ties, then a tie, and or the hand closest to nine.
12) All tie hand is drawn once card each to competitor to compete if there are tie repeats continuing drawing until has a winner then the War pool rewarded to the winner. FIG. 9-10
13) A player first two cards initial hand rewarded BAC(119) wager closest to nine than dealer and WAR(100) wager is pushed.
14) The player first two cards initial hand forfeit his/her BAC(119) wager if score lower than dealer hand and WAR(100) is pushed
15) The player and dealer is tie of initial hand then BAC/WAR(119/100) wagers shall be competing by each of player and dealer draw once card. See FIGS. 6-8
16) The player wins if his/her scored higher than dealer hand then rewarded BAC(119), and WAR(100) wager maybe pushed it is direction of casino to hosting game.
17) The player who lost will forfeit the BAC/WAR(119/100) if his/her hand lowest scores than Dealer.
18) The player and dealer repeats tie then continue draw once card of each hand until has a winner. See FIGS. 6-8
19) In this disclosure the player's initial hand is played against the dealer's initial hand, if a tie hand then each of player and dealer draw once card, and if repeats tie then draw once more or continue drawing until has a winner. Each draw only one card to each players and dealer. (See FIG. 8)
20) The WAR pool center (105) start competition: any ties hands of players including the dealer uses the initial two card hands to compete;
A: the highest of multi-tiers tie hand shall be compete each of ties hand receives once or more cards whoever the highest scored closed to nine there is a winner if there are repeat tie then continue until has a winner. The lower tier tie shall be terminated.
B: A tie hand shall draw once or more cards until has a winner.
C: The highest score of initial hand closed to nine then won the WAR Pool. See FIGS. 11-14

What is claimed is:

1. A method of playing a card game including a war game component, the method comprising:
dealing a hand of cards to each of one or more players and to a dealer;
calculating a score of each hand of cards dealt to the one or more players and the dealer;
identifying whether or not there is a winner according to the calculated score based on a set of predetermined scoring rules;
dealing at least one war card to the one or more players and the dealer when no single winner is identified when the calculated score is a tie score; and
identifying a winner according to a highest value of the war card of each of the one or more players and the dealer based on one of the predetermined scoring rules.

2. The method according to claim 1, wherein if the highest value of the war card is a tie value among more than the one or more players and the dealer, dealing additional war cards among the one or more players and the dealer until a highest value war card is received among the one or more players and the dealer.

3. The method according to claim 1, wherein dealing the hands of cards comprises dealing electronic cards.

4. The method according to claim 1, wherein dealing the hands of cards comprises dealing physical playing cards.

5. The method according to claim 1, wherein the card game and the predetermined scoring rules are based on baccarat.

6. The method according to claim 5, further comprising prompting each of the one or more players for a baccarat wager.

7. The method according to claim 6, further comprising prompting each of the one or more players for a war card wager.

8. The method according to claim 5, further comprising receiving from at least one of the one or more players a baccarat wager and a war card wager.

9. The method according to claim 5, wherein the winner is identified based on the calculated score being closest to 9 in which a tens place digit is dropped off the calculated score when the score exceeds 9.

10. The method according to claim 1, wherein the predetermined scoring rules are based on one of blackjack or Texas Hold'em.

11. The method according to claim 1, further comprising prompting the one or more players for a first wager for a winning score and a second wager for the war card.

12. A computer device for playing a baccarat war card game, comprising:
one or more processors;
a memory coupled to the processor, the memory storing non-transitory executable instructions to cause the processor to perform acts comprising:
dealing a hand of cards to each of one or more players and to a dealer;
calculating a score of each hand of cards dealt to the one or more players and the dealer;
identifying whether or not there is a winner according to the calculated score based on a set of predetermined scoring rules;
dealing at least one war card to the one or more players and the dealer when no single winner is identified when the calculated score is a tie score; and
identifying a winner according to a highest value of the war card of each of the one or more players and the dealer based on one of the predetermined scoring rules.

13. The device according to claim 12, further comprising a mobile communication terminal comprising a transceiver configured for at least one of a WiFi and/or a cellular communication, and
wherein the mobile communication terminal communicates with the dealer via a server or a peer-to-peer communication.

14. The device according to claim 12, wherein the non-transitory executable instructions stored in the memory comprises a smartphone application.

15. The device according to claim 12, wherein additional non-transitory executable instructions when executed by the processor calculates the predetermined scoring rules according to one of blackjack or Texas Hold'em.

16. The device according to claim 12, wherein additional non-transitory executable instructions when executed by the processor performs additional acts comprising operating a Baccarat war game and calculating the predetermined scoring rules according to baccarat war rules.

17. The device according to claim 12, wherein additional non-transitory executable instructions when executed by the processor performs additional acts comprising if the highest value of the war card is a tie value among more than the one or more players and the dealer, dealing additional war cards among the one or more players and the dealer until a highest value war card is received among the one or more players and the dealer.

18. The device according to claim 12, wherein additional non-transitory executable instructions when executed by the processor performs additional acts comprising identifying the winner based on the calculated score being closest to 9 in which a tens place digit is dropped off the calculated score when the score exceeds 9.

19. The device according to claim 12, wherein additional non-transitory executable instructions when executed by the processor performs additional acts comprising calculating a highest value of a plurality of war cards for each player according to aggregate point values of the war cards based on baccarat scoring.

20. A non-transitory computer-readable storage medium tangibly embodying a computer-readable program code having computer-readable instructions that, when executed, causes a computer device to carry out a method of playing a baccarat war card game, the method comprising:
dealing a hand of cards to each of one or more players and to a dealer;
calculating a score of each hand of cards dealt to the one or more players and the dealer;
identifying whether or not there is a winner according to the calculated score based on a set of predetermined scoring rules;
dealing at least one war card to the one or more players and the dealer when no single winner is identified when the calculated score is a tie score; and
identifying a winner according to a value of the war card of the one or more players war card and the dealer based on one of the predetermined scoring rules.
